(19) United States
(12) Patent Application Publication
(10) Pub. No.: US 2013/0171667 A1
(43) Pub. Date: Jul. 4, 2013

(54) PHOTONIC CRYSTAL FIBER SENSOR

(71) Applicants: Dinish Unnimadhava Kurup Soudamini Amma, Singapore (SG); Chit Yaw Fu, Singapore (SG); Malini Olivo, Singapore (SG); Kiat Seng Jason Soh, Singapore (SG)

(72) Inventors: Dinish Unnimadhava Kurup Soudamini Amma, Singapore (SG); Chit Yaw Fu, Singapore (SG); Malini Olivo, Singapore (SG); Kiat Seng Jason Soh, Singapore (SG)

(73) Assignee: Agency for Science, Technology and Research, Connexis (SG)

(21) Appl. No.: 13/702,927

(22) PCT Filed: Jun. 9, 2011
(86) PCT No.: PCT/SG2011/000206

§ 371 Date: Mar. 1, 2013

(30) Foreign Application Priority Data
Jun. 9, 2010 (SG) 201004048-3

(51) Int. Cl. G01N 21/65

(52) U.S. Cl. CPC G01N 21/658
USPC 435/7.23; 435/287.2; 427/162

(57) ABSTRACT

A method for sensing, a photonic crystal fiber, a method for fabricating a photonic crystal fiber sensor, and a Surface Enhanced Raman Scattering (SERS) sensing apparatus. The method for sensing comprises the steps of providing a photonic crystal fiber comprising a hollow core and a plurality of cladding holes around the hollow core; providing Surface Enhanced Raman Scattering (SERS) active nanoparticles; and adapting the SERS active nanoparticles and/or the fiber for SERS sensing.

### FIELD OF INVENTION

The present invention relates broadly to a method of sensing, to a photonic crystal fiber, to a method for fabricating a photonic crystal fiber sensor, and to a Surface Enhanced Raman Scattering (SERS) sensing apparatus.

### BACKGROUND

Surface Enhanced Raman Scattering (SERS) is a versatile sensing and analytical technique where an analyte is adsorbed on to a nano-roughened noble metal surface or onto their colloidal particles, mainly gold (Au) or silver (Ag). Due to the surface plasmonic effect, the analyte molecules experience significant increase in field intensity; hence, the detectable scattering signal also increases several folds. An SERS spectrum of a molecule typically comprises peaks or bands, which uniquely represent a specific set of atomic groups/species present in the respective analyte. This salient feature enables formation of a Raman spectrum of molecules that can represent the analyte's vibrational frequencies and offers a platform for the ‘fingerprint’ characterization.

Incorporation of SERS phenomena along with optical fibers can offer the flexibility for use in in-vivo sensing of biological samples. Initially, conventional fibers with different configurations such as flat, angled, or tapered tip have been tested as SERS platforms. FIG. 1 shows a schematic diagram of a SERS sensing platform using a conventional optical fiber. The excitation light is coupled into the fiber 110 from one end (the measuring end 102) while the sample (analyte) enters the fiber 110 at the other end (the probing end 104). The excitation light propagates in the fiber 110 and interacts directly with the analyte adsorbed onto the nanostructures 120 fabricated at the probing end 104. The SERS signal scattered by the sample propagates through the fiber 110 back to the measuring end 102, and is directed towards the Raman spectrometer 130 through a fiber coupler 140 and an objective lens 150, as shown in FIG. 1.

However, a main limitation of the conventional fiber-based SERS platform is the small number of SERS active nanostructures 120 (FIG. 1) that can be incorporated into the probing end of the optical fiber. This reduces the active area for interaction between the laser light and the analyte. Thus, high laser power and long integration times are often required to achieve high sensitivity for sensing.

As an alternative, photonic crystal fiber (PCF)-based SERS sensing platforms have been proposed where nanoparticles are immobilized on the inner surface of the air holes, and the analyte enters the fiber through capillary action. Conventional PCFs are optical fibers that employ a microstructured arrangement of a low refractive index material in a background material of a higher refractive index. The background material is typically undoped silica and the low refractive index region is provided by air holes along the whole length of the fiber. Usually, PCFs can be divided into two categories, i.e. high index guiding fibers and low index guiding fibers. Structure-wise, a high index guiding fiber has a solid core with microstructured cladding running along the length of the fiber, and is also known as Solid Core PCF (SCPCF). A low index guiding fiber has a hollow core and microstructured cladding, and is also known as Hollow Core PCF (HCPCF). FIGS. 2(a) and 2(b) show scanning electron microscopy (SEM) images, at different magnification levels, of end cross-sections of an SCPCF and a HCPCF respectively.

Low index guiding fibers (or HCPCFs) guide light by the photonic band gap (PBG) effect. Light is confined to the low index core as the PBG effect makes propagation in the microstructured cladding region impossible. The periodic microstructure results in a photonic band gap, where light in certain wavelength regions cannot propagate. This is not possible in normal fibers; hence, this low index guiding property of HCPCFs makes them suitable for many sensing applications.

FIG. 3 shows a cross-sectional view along an axis of a conventional HCPCF having a single layer (herein interchangeably referred to as monolayer) of nanoparticles 310 irregularly immobilized on an inner wall. In the conventional HCPCF, both the nanoparticles 310 and analytes are incorporated in to the HCPCF by capillary action. When the probing end of the fiber is dipped into the nanoparticles (e.g. in a liquid/solution) followed by drying, a monolayer of nanoparticles is immobilized on the inner walls of both the core and cladding holes in an uncontrolled manner. As a result, during sensing, the SERS signal intensity may vary from fiber to fiber and this may lead to poor reliability, e.g. when an intensity-based biosensor is desired.

Also, this conventional HCPCF-based sensing is typically suitable for the sensing of dried analytes (i.e. analytes in the form of liquids that are filled into the fiber holes by capillary action and then dried by keeping the fiber in a hot environment). When a liquid analyte enters both the core and cladding together, the effective refractive index between core and cladding may be reduced, which leads to inefficient light guiding in the core. In some instances where a single layer of nanoparticles is immobilized inside the core/cladding of fiber in an uncontrolled way, the guided light may see the photonic band gap at core-cladding interface, which may prevent the guiding of light when the core holes are filled with liquid samples. Moreover, as shown in FIG. 3, light inside the hollow core can still leak to the cladding as an evanescent wave.

To overcome the above limitation of HCPCF liquid sensing, collapsing of cladding holes have been carried out in the art. In one existing approach, cladding holes are selectively sealed by exposing the cleaved end of the fiber to a high temperature flame (˜1000° C.) for 3-5 seconds (s). This results in the closing of the cladding holes and leaving the central hollow core open. After annealing, the processed probing tip is cooled down for about 5 minutes and then dipped into the solution containing metal nanoparticles for depositing the monolayer of nanoparticles. The thus fabricated probing tip is then dipped into analyte solution for sensing. Due to capillary action, the hollow core is filled by the solution and light is guided through the liquid-filled core. In other approaches, selective closing of cladding holes can be achieved by a fusion splicer.

However, a major challenge in the above approach is to ensure the selective sealing of cladding holes only while leaving core hole undisturbed. High temperature treatment/fusion splicer methods to selectively close the cladding holes may also result in the destruction of hollow core. Once the core hole is disturbed, light guidance can not be controlled, hence making the above technique a less reliable liquid sensing SERS platform.

A need therefore exists to provide a photonic crystal fiber sensor that seeks to address at least some of the above problems.

### SUMMARY

In accordance with a first aspect of the present invention, there is provided a method for sensing, the method comprising the steps of:

providing a photonic crystal fiber comprising a hollow core and a plurality of cladding holes around the hollow core;

providing Surface Enhanced Raman Scattering (SERS) active nanoparticles; and

adapting the SERS active nanoparticles and/or the fiber for SERS sensing.

Adapting the SERS active nanoparticles and/or the fiber for SERS sensing may comprise immobilising one or more layers of the SERS active nanoparticles on respective inner surfaces of the hollow core and cladding holes.

Immobilising the one or more layers of the SERS active nanoparticles on respective inner surfaces of the hollow core and cladding holes may comprise:

charging the respective inner surfaces of the hollow core and cladding holes; and

depositing the SERS active nanoparticles on the charged surfaces.

Immobilising the one or more layers of the SERS active nanoparticles on respective inner surfaces of the hollow core and cladding holes may comprise using a di-thiol linker molecule to link adjacent layers of the nanoparticles.

The method may further comprise controlling a separation between adjacent SERS active nanoparticles to be in the range of about 10 to 20 nm.

The SERS active nanoparticles may be immobilized over the entire length of the fiber.

Adapting the SERS active nanoparticles and/or the fiber for SERS sensing may comprise tuning a plasmonic resonance wavelength of the SERS active nanoparticles with a predetermined wavelength of an excitation light.

The SERS active nanoparticles may comprise metal nanoshells, and tuning the plasmonic resonance wavelength of the SERS active nanoparticles may comprise adjusting a ratio of a core radius to a shell thickness of the metal nanoshells.

The SERS active nanoparticles may comprise metal nanorods, and tuning the plasmonic resonance wavelength of the SERS active nanoparticles may comprise adjusting an aspect ratio of a length over a width of metal nanorods.

The plasmonic resonance wavelength of the SERS active nanoparticles may be in the near infra-red (NIR) range.

The method may further comprise:

disposing one end of the photonic crystal fiber in a liquid sample for binding a protein in the sample to the SERS active nanoparticles;

providing an excitation light to the photonic crystal fiber; and

collecting a SERS signal scattered by the SERS active nanoparticles for sensing the protein.

In accordance with a second aspect of the present invention, there is provided a photonic crystal fiber comprising:

a hollow core;

a plurality of cladding holes around the hollow core; and

Surface Enhanced Raman Scattering (SERS) active nanoparticles disposed in the hollow core and the cladding holes;

wherein the SERS active nanoparticles and/or the fiber are adapted for SERS sensing.

The SERS active nanoparticles and/or the fiber may be adapted such that one or more layers of the SERS active nanoparticles may be immobilised on respective inner surfaces of the hollow core and the cladding holes.

The respective inner surfaces of the hollow core and the cladding holes may be charged and the SERS active nanoparticles may be deposited on the charged surfaces, for immobilising the one or more layers of the SERS active nanoparticles.

A di-thiol linker molecule may be used to link adjacent layers of the nanoparticles, for immobilising the one or more layers of the SERS active nanoparticles.

A separation between adjacent SERS active nanoparticles may be in the range of about 10 to 20 nm.

The SERS active nanoparticles may be immobilized over the entire length of the fiber.

The SERS active nanoparticles and/or the fiber may be adapted such that a plasmonic resonance wavelength of the SERS active nanoparticles may be tuned with a predetermined wavelength of an excitation light.

The SERS active nanoparticles may comprise metal nanoshells, and a ratio of a core radius to a shell thickness of the metal nanoshells may be adjusted for tuning the plasmonic resonance wavelength.

The SERS active nanoparticles may comprise metal nanorods, and an aspect ratio of a length over a width of metal nanorods may be adjusted for tuning the plasmonic resonance wavelength.

The plasmonic resonance wavelength of the SERS active nanoparticles may be in the near infra-red (NIR) range.

In accordance with a third aspect of the present invention, there is provided a Surface Enhanced Raman Scattering (SERS) sensing apparatus comprising the photonic crystal fiber as defined in the second aspect.

In accordance with a fourth aspect of the present invention, there is provided a method for fabricating a photonic crystal fiber sensor, the method comprising disposing Surface Enhanced Raman Scattering (SERS) active nanoparticles in a hollow core and a plurality of cladding holes around the hollow core of a photonic crystal fiber; wherein the SERS active nanoparticles and/or the fiber are adapted for SERS sensing.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic diagram of a SERS sensing platform using a conventional optical fiber.

FIGS. 2(a) and 2(b) show scanning electron microscopy (SEM) images, at different magnification levels, of end cross-sections of an SCPCF and a HCPCF respectively.

FIG. 3 shows a cross-sectional view along an axis of a conventional HCPCF having a single layer of nanoparticles irregularly immobilized on an inner wall.

FIG. 4 shows graphs comparing SERS intensity obtained from a normal fiber and a hollow core PCF at normalized experimental conditions.

FIG. 5 shows graphs comparing SERS intensity obtained from an SCPCF and a HCPCF at normalized experimental conditions.

FIG. 6(a) shows a cross-sectional view along an axis illustrating immobilization of multiple layers of nanoparticles inside a hollow core of the HCPCF according to an example embodiment.

FIG. 6(b) shows an isometric view of a portion of a HCPCF according to an example embodiment.

FIGS. 7(a), 7(b) and 7(c) show simulation results of electric field intensity distribution around a single nanoparticle, a dimer configuration of two nanoparticles in large separation, and a dimer configuration of two nanoparticles in close separation respectively.

FIGS. 8(a)-8(b) show enlarged images illustrating immobilization of the nanoparticles using thiol chemistry according to an example embodiment.

FIG. 9 shows a flow chart illustrating a method for sensing according to an example embodiment.

FIG. 10 shows a schematic diagram illustrating SERS binding of the bioconjugated SERS nanotag to the complimentary proteins inside the core/cladding hole of the PCF.

FIG. 11 shows graphs of SERS spectrum obtained from an example experimental application.

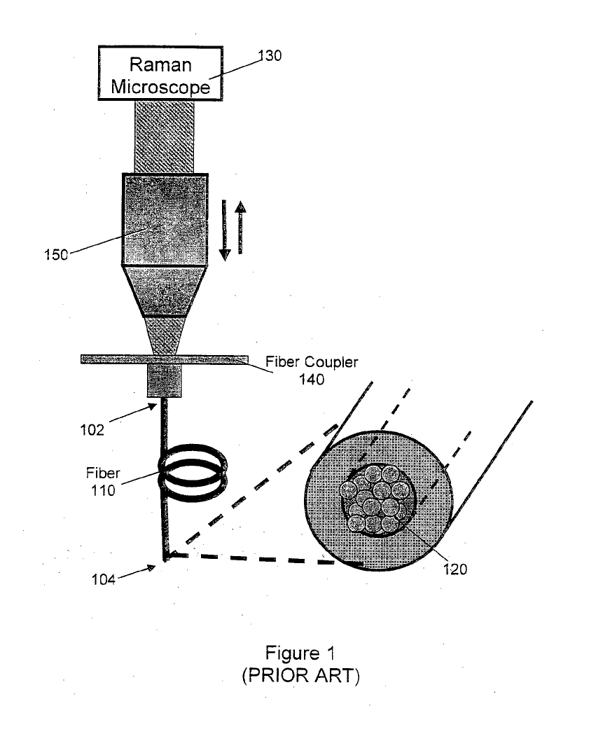

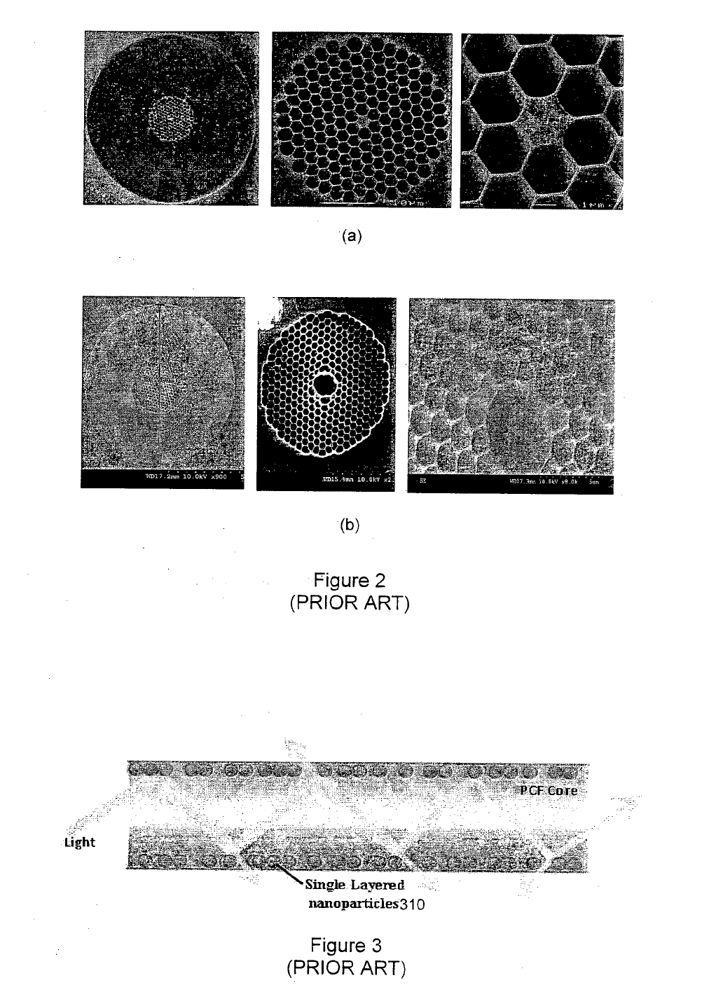

### DETAILED DESCRIPTION

Embodiments of the present invention provide a photonic crystal fiber (PCF) and a PCF-based SERS sensing platform for the detection of about picogram-level concentration of proteins in a nanoliter-level sample volume. Embodiments of the present invention further provide an in-vivo tunable SERS sensing platform inside a HCPCF using metallic nanoshells/nanorods.

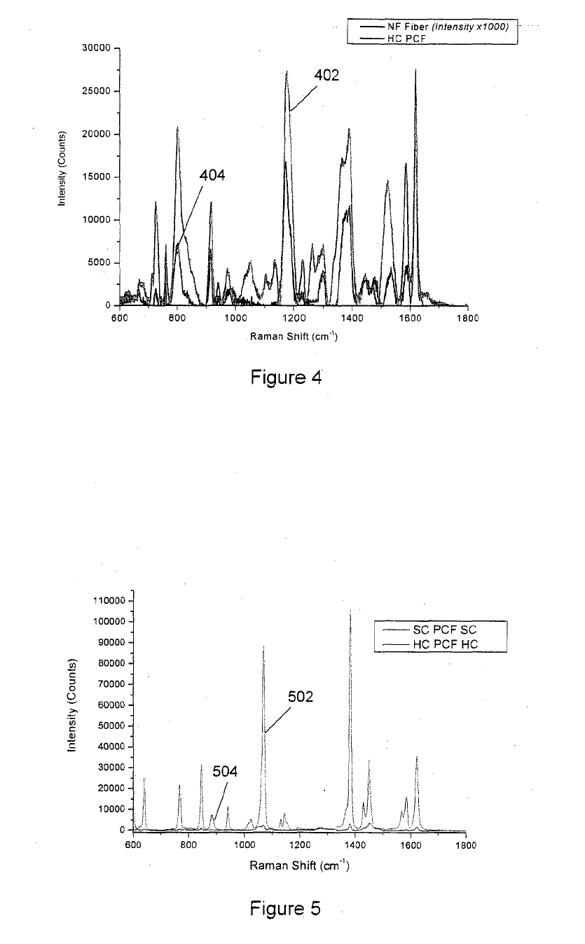

The inventors have conducted a comparative SERS study of normal fiber (NF) having core diameter of about 1 millimeter (mm) and a hollow core PCF (HCPCF) having a core diameter of about 6 micrometers (μm). The SERS active substrate is fabricated in the NF by the Metal Film Over Nanosphere (MFON) technique where polystyrene beads having a diameter of about 400 nanometers (nm) are closely packed at the core of the probing end, followed by 20 nm silver (Ag) coating. The SERS active area is fabricated in the HCPCF by dipping the probing end of the fiber in a 40 nm citrate stabilized gold (Au) colloid solution, followed by drying. Due to capillary action, these nanoparticles enter the core and cladding holes, forming a SERS active area of nanoparticles. The fibers (NF and HCPCF) thus fabricated have been tested in SERS mode using a strong Raman active molecule, e.g. Crystal Violet (CV) at an analyte concentration of 100 μM using 785 nm laser excitation. FIG. 4 shows graphs comparing SERS intensity obtained from a normal fiber (line 404) and a hollow core PCF (line 402) at normalized experimental conditions. As shown in FIG. 4, the SERS intensity from the NF is about 3-4 orders lower than that from the HCPCF (here it should be noted that the SERS intensity spectrum from the NF has been multiplied by 1000 times for a better representation). This study confirms that HCPCF can provide significantly greater sensitivity than HF, e.g. for sensitive SERS sensing of biological analytes.

In addition, the performance of an SCPCF and a HCPCF has also been compared at identical experimental conditions. In an example study, SERS active 40 nm Au nanoparticles are immobilized in the air holes of the cladding of the SCPCF, and inside both the cladding and the hollow core of the HCPCF by capillary action, followed by drying of the respective fibers. The functionalized fibers have been tested at identical experimental settings using a 100 μM 2-Naphthalene-Thiol (NT) solution as the Raman active molecule. FIG. 5 shows graphs comparing SERS intensity obtained from an SCPCF (line 504) and a HCPCF (line 502) at normalized experimental conditions. As shown in FIG. 5, the SERS intensity obtained from the HCPCF is at least 1 order higher than that from the SCPCF.

The PCF in the example embodiments thus comprises a HCPCF, which can provide superior performance compared to other types of fibers, as discussed above. Additionally, in the example embodiments, both core and cladding holes of the HCPCF are used for sensing such that both the interaction length and sensitivity are increased. In a preferred embodiment, one or more layers (herein interchangeably referred to as a multi-layer) of SERS active nanoparticles are controllably immobilized on the inner walls of both the core and cladding holes. Such controlled multilayer immobilization of the nanoparticles can be achieved for example by making the surface charged, followed by deposition of the nanoparticles; or using di-thiol chemistry to systematically link different layers of nanoparticles, in an example embodiment.

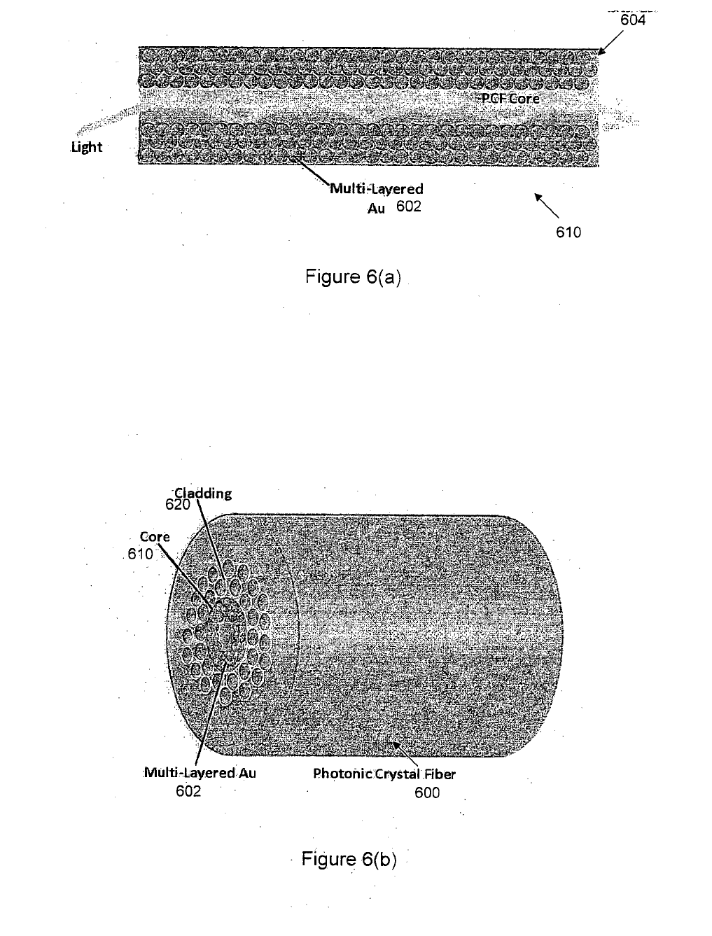

FIG. 6(a) shows a cross-sectional view along an axis illustrating immobilization of multiple layers of nanoparticles 602 inside a hollow core 610 of the HCPCF according to an example embodiment. As shown in FIG. 6(a), the nanoparticles 602 (e.g. Au or Ag) are closely and orderly arranged on the inner wall 604. In FIG. 6(a), 3 layers of the nanoparticles 602 are shown, however, it will be appreciated that different numbers of layers (e.g. 1, 2 or more) may be used in other embodiments. In the example embodiments, once the multilayer of nanoparticles 602 are immobilized on the inner walls, e.g. 604, of core and cladding holes, each of the core and cladding holes acts as an independent, internally highly reflective light guiding capillary tube. As a result, the light guided in the core does not see the photonic band gap at the core-cladding interface. The HCPCF according to the example embodiments is thus capable of guiding light even in the liquid filled core, and is suitable for SERS sensing of liquid analytes without the removal of cladding.

FIG. 6(b) shows an isometric view of a portion of a HCPCF 600 according to an example embodiment. Here, both core 610 (see FIG. 6(a)) and cladding holes 620 are immobilized with multiple layers of nanoparticles 602 (see FIG. 6(a)) in a controlled manner, as described above. In example embodiments, the one or more layers of nanoparticles 602 are preferably immobilized over the entire fiber length of the HCPCF 600. However, the one or more layers of nanoparticles may be immobilized over a portion of the fiber length in different embodiments. The cladding holes 620 can be used in the example embodiments to further increase the sensitivity of the HCPCF 600 because each cladding hole 620 along with central hollow core 610 can guide light, which in turn makes the HCPCF 600 a bundle of light guiding capillary tubes, e.g. in embodiments where the nanoparticles 602 are immobilized over the entire fiber length.

Also, the multiple layers of nanoparticles 602 immobilized on the inner walls as shown e.g. in FIG. 6(b) can increase the roughness along the inner walls and more hotspots (e.g. regions of high field intensity) can be generated, leading to the greater enhancement of the SERS signal. This can help in improving the sensitivity of e.g. biosensing of analytes. Moreover, the multilayer immobilization of the nanoparticles changes the inner diameters of the fiber's core and cladding holes. In the example embodiments, this can be used to control the capillary action to fill the analytes.

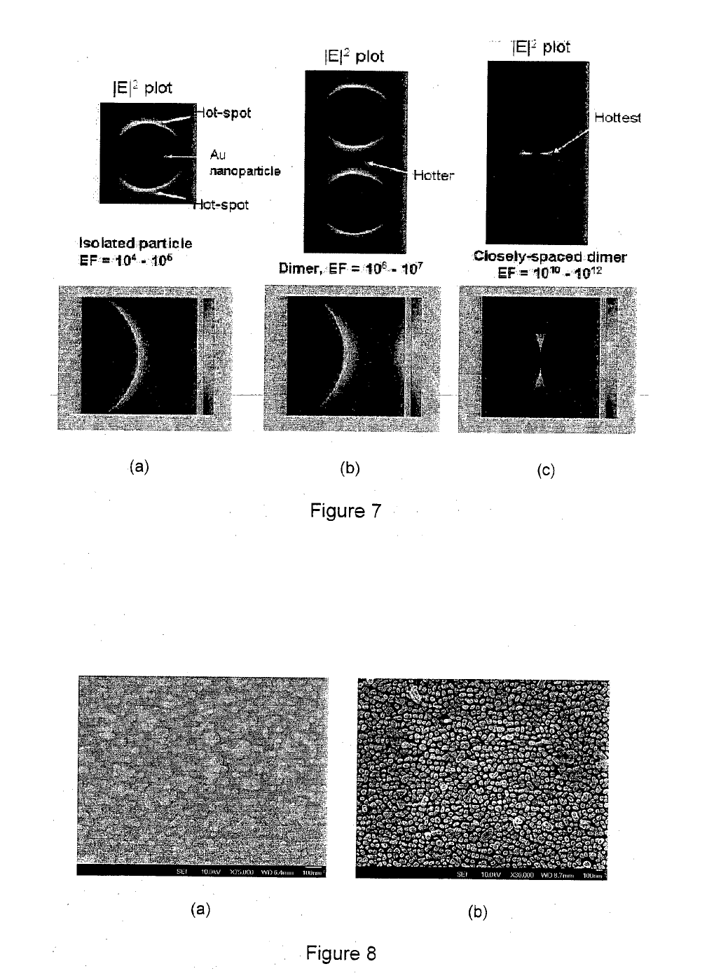

FIGS. 7(a), 7(b) and 7(c) show simulation results of electric field intensity distribution around a single nanoparticle, a dimer configuration of two nanoparticles in large separation, and a dimer configuration of two nanoparticles in close separation respectively. As shown in FIG. 7(a), the enhancement factor (EF) of a SERS signal from a single nanoparticle can be up to 10⁴-10⁵, while in the case of the dimer configuration with large separation (FIG. 7(b), the EF is in the range of 10⁶-10⁷. In the dimer configuration with close separation (FIG. 7(c)), which is substantially similar to the arrangement of the nanoparticles shown in FIG. 6(a), the EF is optimized and can be as high as 10¹⁰-10¹². In other words, in the example embodiments, the nanoparticles are packed closely and regularly such that the SERS enhancement can be increased significantly.

An example method of fabricating the multilayer of nanoparticles packed in a close and ordered way comprises using thiol chemistry. For example, a di-thiol linker molecule is used to connect two layers of nanoparticles. FIGS. 8(a)-8(b) show enlarged images illustrating immobilization of the nanoparticles using thiol chemistry according to an example embodiment. By properly adjusting the fabrication protocol (fabrication conditions and sequence) such as adjusting the thiol concentration, nanoparticle concentration, etc., the nanoparticles can be packed in a close range to form multiple layers, e.g. in FIG. 8(b). For example, the separation between adjacent nanoparticles is in the range of about 10-20 nm in some embodiments. At such example separation range, specific and predictable generation of hotspots (regions of strong field enhancement as discussed with respect to FIG. 7) can be achieved in the example embodiments. The signal intensity in the HCPCF thus fabricated can be relatively uniform and stable.

Further, in the example embodiments, sensitivity in SERS sensing is improved by matching the laser excitation wavelength with plasmonic wavelength of the nanoparticles. In a preferred embodiment, the nanoparticles comprise metal nanoshells. In another preferred embodiment, the nanoparticles comprise metal nanorods. Core and shell dimensions of the metal nanoshells are used to systematically tune the plasmon resonance of the nanoshells, while adjusting an aspect ratio (e.g. length divided by width) of the nanorods helps plasmonic tuning in the nanorods in the example embodiments. For example, the metal nanoshells in the example embodiments comprise 90-130 nm particles of silica coated with a thin layer of gold or silver, capable of absorbing and scattering light at specific frequencies. The tunable property of nanoshells is achieved in the example embodiments e.g. by changing the ratio of the silica core to the metal thickness. The tunable property of the nanoshell is achieved by changing the aspect ratio of nanorods. For example, the aspect ratio can be adjusted to be in the range of about 3-10.

The plasmon resonant wavelength of the metal nanoshells/nanorods can thus be tuned from e.g. the visible region to the near infra red (NIR) region of the spectrum. This is a significantly broader tuning range compared to e.g. tuning by changing the size of solid nanoparticles. Also, the wavelength at the NIR region can better match with the optimized laser excitation length for in-vivo SERS sensing (longer excitation wavelengths around NIR region does not suffer from interference of fluorescence generated by un-bound and non-specific molecules present in the analytes, and are thus preferred for in vivo sensing). Thus, sensitivity is improved in the example embodiment.

The metal nanoshells in the example embodiments include gold or silver nanoshells, and the plasmonic property of these nanoshells is changed e.g. by changing the core radius to shell thickness ratio. By adjusting this value, it is possible to achieve the metal nanoshells with maximum absorption in the NIR or other desired ranges. Similarly, the aspect ratio of the metal nanorods can be adjusted to achieve maximum absorption in the NIR or other desired ranges. Hence, in the SERS sensing platform of the example embodiments, it is possible to achieve a matching of plasmonic property of the nanoshells/nanorods to the laser excitation at NIR wavelength to yield maximum sensitivity in sensing. Such a tunable platform is particularly suitable for in-vivo biosensing applications.

As described above, the PCF according to the example embodiments is suitable for in-vivo sensing applications. The PCF of the example embodiments advantageously allows analyte molecules to be absorbed into the air holes of the core and/or the cladding thereby increasing the interaction length between the excitation laser and, analyte. The cladding holes can also be used for guiding light, thus advantageously increasing sensitivity during sensing. The PCF according to the example embodiments can thus be used for sensing biological samples even at low volumes and concentrations. Moreover, in the example embodiments, removal of cladding holes is preferably avoided, and light is guided through the fiber.

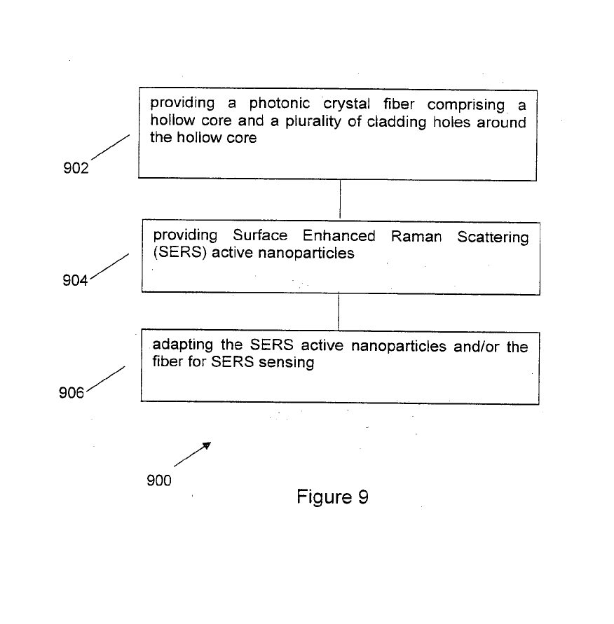

FIG. 9 shows a flow chart 900 illustrating a method for sensing according to an example embodiment. At step 902, a photonic crystal fiber comprising a hollow core and a plurality of cladding holes around the hollow core is provided. At step 904, Surface Enhanced Raman Scattering (SERS) active nanoparticles are provided. At step 906, the SERS active nanoparticles and/or the fiber are adapted for SERS sensing.

The inventors have applied the method and apparatus of the example embodiments to in-vivo sensing, e.g. protein sensing using functionalized nanotags inside a HCPCF. In an example experimental application, lysate solutions from epidermal growth factor receptor (EGFR) expressing head and neck carcinoma cells have been immobilized into the PCF for protein binding and detected using anti-EGFR antibody conjugated SERS nanotag. The SERS nanotag is fabricated by immobilization of highly Raman active molecule such as malachite green isothiocyanate (MGITC) on to Au colloid and followed by Polyethylene glycol (PEG) encapsulation. The reporter molecule can be any strongly active molecule that has the two features of being able to bind to Au nanoparticles and being able to produce intense Raman spectra. Here, protein is immobilised first and then treated with functionalized nanoparticles. However, it will be appreciated that nanoparticle-based tags can be immobilized first and then the protein (present in the analytes) is introduced, as described above.

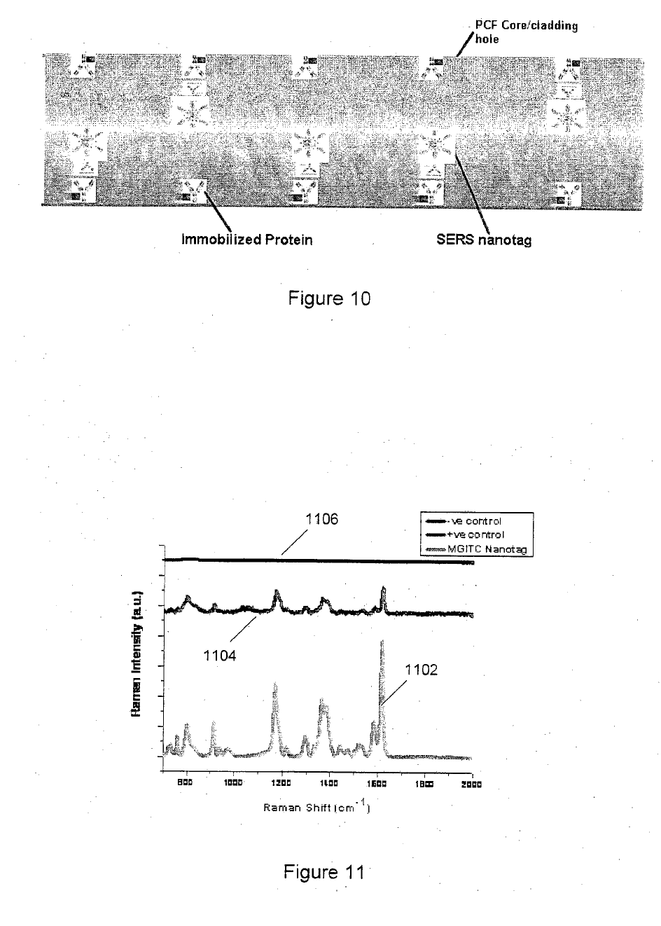

FIG. 10 shows a schematic diagram illustrating SERS binding of the bioconjugated SERS nanotag to the complimentary proteins inside the core/cladding hole of the PCF. Here, SERS nanotags can be prepared by incubating Raman reporter molecules (here MGITC) dye with gold colloid for about 10 minutes. This is followed by PEG encapsulation. For example, thiolated-carboxylated PEG is added to the solution and incubated for about 20 minutes. After that, simple thiolated PEG solution is added to the mixture and incubated for about 3 hours. This is followed by centrifugation and washing to remove the excess PEG from the solution. In order to conjugate EGFR antibody to the nanotag, ethyl dimethylaminopropyl carbodiimide (EDC) coupling reaction is carried out. In simple, EGFR antibody is first prepared by centrifuging and removing the preservative sodium azide. This is followed by addition of EDC and sulfo-N-hydroxysuccinimide (NHS) to activate the carboxyl groups of PEG-COOH on the MGITC nanotag. Finally, EGFR antibody is added to the solution and the mixture is incubated for 2 hours at room temperature.

Further, air channels of the PCF are treated with poly-L-lysine for later binding of proteins. Poly-L-lysine can be incorporated to PCF holes by simple capillary action. After that, lysate solutions expressing EGFR protein are infiltrated into the PCF followed by washing to remove proteins that is not immobilized by poly-L-lysine. Here, a A431 cell line is used as the EGFR positive cell line, while MCF 7 is used as EGFR negative cell line. Finally, anti EGFR antibody conjugated SERS nanotag is also incorporated to the PCF channels, Antibody conjugated SERS nanotag binds to the immobilized proteins (from the A431 cell line) and all unbound SERS nanotags are removed by thorough washing of the fiber.

FIG. 11 shows graphs of SERS spectrum obtained from an example experimental application. Here the SERS spectrum is obtained from MGITC anchored SERS nanotag adsorbed inside the HCPCF immobilized with EFFR positive and negative proteins and excited at 633 nm laser. Line 1102 represents the SERS spectrum of pure MGITC nanotag, while line 1104 shows the corresponding spectrum obtained from fiber immobilized with EGFR proteins, and line 1106 represents the spectrum from negative control. As can be seen from FIG. 11, the fiber with EGFR positive bound to anti EGFR MGITC nanotag (see line 1104) shows spectral signatures at 1617, 1390, 1171 and 914 cm⁻¹, clearly matching with pure nanotag spectrum (line 1102). That is, when the protein binds to functionalized SERS nanoparticles, sensitive sensing can be achieved. The sensitivity can be further improved in the example embodiments by using nanoshells/nanorods instead of the nanoparticles.

A method for fabricating a photonic crystal fiber sensor according to an example embodiment comprises disposing Surface Enhanced Raman Scattering (SERS) active nanoparticles in a hollow core and a plurality of cladding holes around the hollow core of a photonic crystal fiber; wherein the SERS active nanoparticles and/or the fiber are adapted for SERS sensing:

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1-23. (canceled)

24. A method for sensing, the method comprising the steps of:
providing a photonic crystal fiber comprising a hollow core and a plurality of cladding holes around the hollow core;
providing Surface Enhanced Raman Scattering (SERS) active nanoparticles; and
adapting the SERS active nanoparticles and/or the fiber for SERS sensing, wherein adapting the SERS active nanoparticles and/or the fiber for SERS sensing comprises controllably immobilising one or more layers of the SERS active nanoparticles on respective inner surfaces of the hollow core and cladding holes.

25. The method as claimed in claim 24, wherein immobilising the one or more layers of the SERS active nanoparticles on respective inner surfaces of the hollow core and cladding holes comprises:
charging the respective inner surfaces of the hollow core and cladding holes; and
depositing the SERS active nanoparticles on the charged surfaces.

26. The method as claimed in claim 24, wherein immobilising the one or more layers of the SERS active nanoparticles on respective inner surfaces of the hollow core and cladding holes comprises using a di-thiol linker molecule to link adjacent layers of the nanoparticles.

27. The method as claimed in claim 24, further comprising controlling a separation between adjacent SERS active nanoparticles to be in the range of about 10 to 20 nm.

28. The method as claimed in claim 24, wherein the SERS active nanoparticles are immobilized over the entire length of the fiber.

29. The method as claimed in claim 24, wherein adapting the SERS active nanoparticles and/or the fiber for SERS sensing comprises tuning a plasmonic resonance wavelength of the SERS active nanoparticles with a predetermined wavelength of an excitation light.

30. The method as claimed in claim 29, wherein the SERS active nanoparticles comprise metal nanoshells, and wherein tuning the plasmonic resonance wavelength of the SERS active nanoparticles comprises adjusting a ratio of a core radius to a shell thickness of the metal nanoshells.

31. The method as claimed in claim 29, wherein the SERS active nanoparticles comprise metal nanorods, and wherein tuning the plasmonic resonance wavelength of the SERS active nanoparticles comprises adjusting an aspect ratio of a length over a width of the metal nanorods.

32. The method as claimed in claim 29, wherein the plasmonic resonance wavelength of the SERS active nanoparticles is in the near infra-red (NIR) range.

33. The method as claimed in claim 24, further comprising:
disposing one end of the photonic crystal fiber in a liquid sample for binding a protein in the sample to the SERS active nanoparticles;
providing an excitation light to the photonic crystal fiber; and
collecting a SERS signal scattered by the SERS active nanoparticles for sensing the protein.

34. A photonic crystal fiber comprising:
a hollow core;
a plurality of cladding holes around the hollow core; and
Surface Enhanced Raman Scattering (SERS) active nanoparticles disposed in the hollow core and the cladding holes;
wherein the SERS active nanoparticles and/or the fiber are adapted for SERS sensing and wherein the SERS active nanoparticles and/or the fiber are adapted such that one or more layers of the SERS active nanoparticles are controllably immobilised on respective inner surfaces of the hollow core and the cladding holes.

35. The photonic crystal fiber as claimed in claim 34, wherein the respective inner surfaces of the hollow core and the cladding holes are charged and the SERS active nanoparticles are deposited on the charged surfaces, for immobilising the one or more layers of the SERS active nanoparticles.

36. The photonic crystal fiber as claimed in claim 34, wherein a di-thiol linker molecule is used to link adjacent layers of the nanoparticles, for immobilising the one or more layers of the SERS active nanoparticles.

37. The photonic crystal fiber as claimed in claim 34, wherein a separation between adjacent SERS active nanoparticles is in the range of about 10 to 20 nm.

38. The photonic crystal fiber as claimed in claim 34, wherein the SERS active nanoparticles are immobilized over the entire length of the fiber.

39. The photonic crystal fiber as claimed in claim 34, wherein the SERS active nanoparticles and/or the fiber are adapted such that a plasmonic resonance wavelength of the SERS active nanoparticles is tuned with a predetermined wavelength of an excitation light.

40. The photonic crystal fiber as claimed in claim 39, wherein the SERS active nanoparticles comprise metal nanoshells, and wherein a ratio of a core radius to a shell thickness of the metal nanoshells is adjusted for tuning the plasmonic resonance wavelength.

41. The photonic crystal fiber as claimed in claim 39, wherein the SERS active nanoparticles comprise metal nanorods, and wherein an aspect ratio of a length over a width of the metal nanorods is adjusted for tuning the plasmonic resonance wavelength.

42. The photonic crystal fiber as claimed in claim 39, wherein the plasmonic resonance wavelength of the SERS active nanoparticles is in the near infra-red (NIR) range.

43. A Surface Enhanced Raman Scattering (SERS) sensing apparatus comprising the photonic crystal fiber as claimed in claim 34.

44. A method for fabricating a photonic crystal fiber sensor, the method comprising disposing Surface Enhanced Raman Scattering (SERS) active nanoparticles in a hollow core and in a plurality of cladding holes around the hollow core of a photonic crystal fiber;
wherein the SERS active nanoparticles and/or the fiber are adapted for SERS sensing and wherein the SERS active nanoparticles and/or the fiber are adapted such that one or more layers of the SERS active nanoparticles are controllably immobilised on respective inner surfaces of the hollow core and the cladding holes.
